(19) United States
(12) Patent Application Publication
(10) Pub. No.: US 2010/0015373 A1
(43) Pub. Date: Jan. 21, 2010

(54) INFLATABLE STRUCTURE

(76) Inventor: Chiang-Chuan LIN, Taoyuan County (TW)

Correspondence Address: Muncy, Geissler, Olds & Lowe, PLLC, P.O. BOX 1364, FAIRFAX, VA, 22038-1364, US

(21) Appl. No.: 12/564,408

(22) Filed: Sep. 22, 2009

Related U.S. Application Data
(63) Continuation-in-part of application No. 11/723,681, filed on Mar. 21, 2007.

(51) Int. Cl. B32B 1/00; A42B 1/06; A41D 19/00; A41D 3/02; A41D 1/06; A47G 9/08

(52) U.S. Cl. 428/36.1; 2/209; 2/159; 2/93; 2/227; 5/413 AM; 5/502

(57) ABSTRACT

An inflatable structure includes a fabric body having three hydrophilic and vapor-transmissible plastic layers sequentially applied over an inner surface thereof, and including at least one continuous S-shaped bonding channel, along which areas on an outer surface of the fabric body at two opposite sides thereof are bonded together. The three hydrophilic and vapor transmissible plastic layers are lightweight, waterproof, vapor transmissible, and warm; and the S-shaped bonding channel has small width to allow increased inflatable space in the fabric body. The continuous S-shaped bonding channel has two ends formed into two closed circular bonding lines to avoid damage of the inflatable structure by stress concentrated at the bonding line.

### FIELD OF THE INVENTION

The present invention relates to an inflatable structure, and more particularly to an inflatable structure that includes a fabric body having three hydrophilic and vapor-transmissible plastic layers sequentially applied and coated over an inner surface thereof, and including at least one continuous S-shaped bonding line, along which areas on an outer surface of the fabric body at two opposite sides thereof are bonded together.

### BACKGROUND OF THE INVENTION

People wear warm clothes, such as a down coat, to protect themselves against cold in winter. The down coat is insulated with loose down, in which air is held to isolate external cold from a wearer's skin. However, when the down is compressed by an external force to expel the air held therein, it becomes less effective in warm keeping. Moreover, since the down is the first soft feathers of birds, it inevitably has the potential problems of bad odor and Avian Influenza. And, some people might be allergic to down.

Some inflatable structures, such as inflatable garments, have been developed to replace the down coat. An inflatable garment usually has inner and outer sides partially bonded together by various bonding manners to form a closed inflatable space in the inflatable garment. Depending on a wearer's need or preference in warm keeping, an adequate amount of air may be conveniently supplied into or released from the inflatable space to isolate external cold air from the wearer's body.

The conventional inflatable structures usually include different plastic materials, which may be generally divided into three types. The first type is PVC (Polyvinyl chloride) material, which has relatively weak bonding strength and therefore requires a minimum thickness of 0.15 to 0.20 mm to ensure a satisfied bonding strength. With the required large thickness, the conventional inflatable structure made with the PVC material is quite heavy. The PVC material also has the disadvantages of being non-breathable and producing dioxin after being burned to become environmentally hazardous. Therefore, the inflatable structure with PVC material has gradually lost its share in the market. The second type is TPU (thermoplastic polyurethane) material, which is thick, heavy, non-vapor-transmissible, and stiff in touch, and requires high processing cost. The third type is a breathable TPU material, which has relatively weak bonding strength and low air-holding ability, and requires extremely high processing cost while the bad yield thereof is very high.

The conventional inflatable structures also have problems with the bonding thereof. FIG. 1 shows a first conventional inflatable structure 1 configured as an inflatable coat. As shown, the inflatable structure 1 must have a plurality of relatively wide straight bonding strips 11 because of the weak bonding strength of the plastic material thereof. Warm air surrounding the wearer's body tends to leak via the wide bonding strips 11, and external cold air may easily invade the inflatable structure 1 via the wide bonding strips 11 to degrade the warm keeping property of the inflatable structure 1. Moreover, stress tends to concentrate at two ends of the straight bonding strips 11 on the conventional inflatable structure 1 to cause damage at the two ends and leakage of air thereat when the inflatable structure 1 is subjected to a relatively large compression.

FIG. 2 shows a second conventional inflatable structure 2 configured as an inflatable coat, too. The inflatable structure 2 includes a plurality of circular bonding areas 21 to solve the problem of stress concentration. However, due to the weak bonding strength of the plastic material of the inflatable structure 2, the circular bonding areas 21 must have a relatively large diameter. Again, warm air surrounding the wearer's body tends to leak via the large circular bonding areas 21, and external cold air may easily invade the inflatable structure 2 via the large circular bonding areas 11 to degrade the warm keeping property of the inflatable structure 2. Moreover, the large circular bonding areas 21 inevitably decreases the air volume that can be held in the inflatable structure 2 to further reduce the warm keeping effect of the inflatable structure 2.

It is therefore tried by the inventor to develop an improved inflatable structure that is lightweight, waterproof, vapor-transmissible, durable, and warm.

### SUMMARY OF THE INVENTION

A primary object of the present invention is to provide an inflatable structure that is lightweight, waterproof, and vapor transmissible. It is another object of the present invention to provide an inflatable structure that has S-shaped bonding channels to strengthen the bonding between fabrics and to increase the insulating property of the structure. Moreover, it is another object of the present invention to provide an inflatable structure that has durable inflatable space, and consist of lightweight, waterproof, vapor-transmissible, heat retaining properties.

To achieve the above and other objects, the inflatable structure according to the present invention includes a fabric body having an inner surface and an outer surface; a solvent-based hydrophilic and vapor-transmissible plastic layer applied to the inner surface of the fabric body; a low-modulus hydrophilic and vapor-transmissible plastic layer provided over the solvent-based hydrophilic and vapor-transmissible plastic layer; a low-melting-point hydrophilic and vapor-transmissible plastic layer provided over the low-modulus hydrophilic and vapor-transmissible plastic layer to enclose an inflatable space therein; at least one continuous S-shaped bonding channel, along which areas on the outer surface at two opposite sides of the fabric body are bonded together to limit an inflated overall thickness of the fabric body, and the S-shaped bonding channel being formed at two ends with a closed circular bonding line each; and an inflating valve provided on the fabric body to communicate with the inflatable space, so that air may be supplied into or released from the inflatable space via the inflating valve. With the above arrangements, the inflatable structure of the present invention is suitable for making different lightweight, waterproof, vapor-transmissible, durable, and warm garments.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a first conventional inflatable structure configured as an inflatable coat;

FIG. 2 is a perspective view of a second conventional inflatable structure configured as an inflatable coat;

FIG. 3 is a perspective view of an inflatable structure according to a preferred embodiment of the present invention;

FIG. 4 is an enlarged sectional view taken along line A-A′ of FIG. 3;

FIG. 5 is a perspective view showing some applications of the inflatable structure of the present invention;

FIG. 6 is a perspective view showing another application of the inflatable structure of the present invention;

FIG. 7 is a perspective view showing a further application of the inflatable structure of the present invention.

FIG. 8 is a perspective view of showing how fabric bodies are bonded together through S-shaped bonding channels in accordance with a preferred embodiment of the present invention;

FIG. 9 is an enlarged sectional view taken along a cutting line of X-X′ of FIG. 8; and

FIG. 10 is an enlarged sectional view taken along a cutting line of Y-Y′ of FIG. 8.

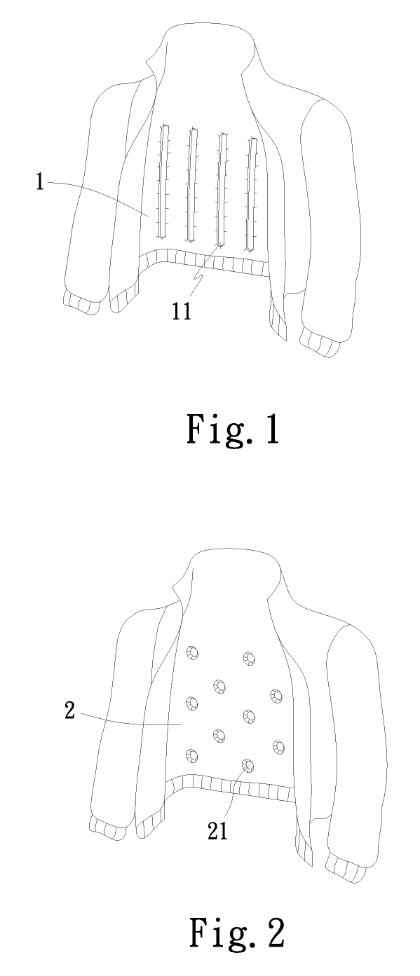

### DETAILED DESCRIPTION OF THE PREFERRED EMBODIMENTS

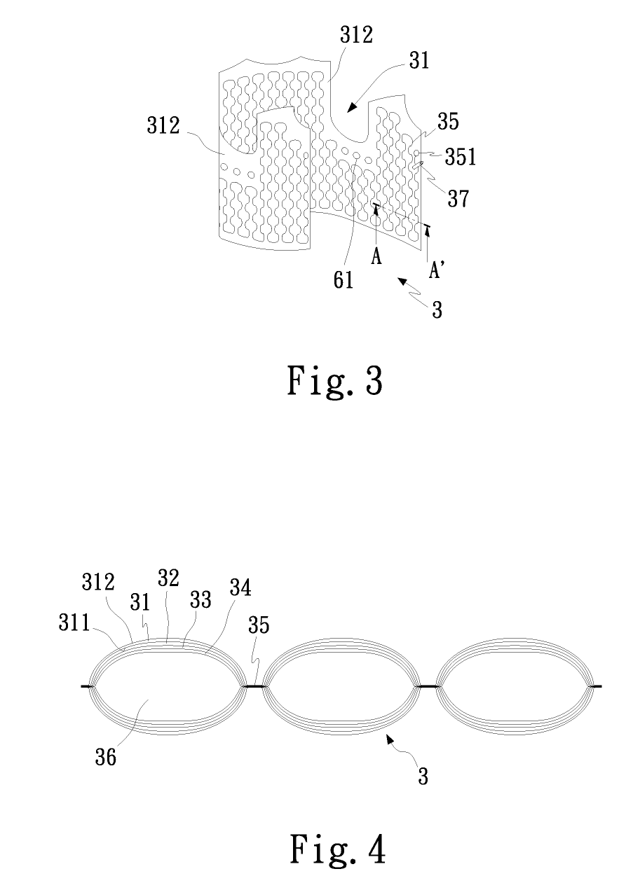

Please refer to FIG. 3 that is a perspective view of an inflatable structure 3 according to a preferred embodiment of the present invention, and to FIG. 4 that is an enlarged sectional view taken along line 4-4 of FIG. 3.

As shown, the inflatable structure 3 comprises at least one fabric body 31 having an inner surface 311 and an outer surface 312, and may be made of a material selected from the group consisting of Nylon compositions or Nylon 66. Various types of fabrics have been experienced tested, in which the Nylon 66 is found to provide the desired results in accordance with a preferred embodiment of the present invention to use as the fabric body 31 of the inflatable structure 3. The Nylon 66 is found to provide the best heat retaining characteristic in according to the tests performed in the present invention.

A solvent-based hydrophilic and vapor-transmissible plastic layer 32 is applied over the inner surface 311 of the fabric body 31, wherein the solvent-based hydrophilic and vapor-transmissible plastic layer 32 is selected from a group that comprises Urethane Polymer or a composition comprising Urethane Polymer, Dimethyl formamide (approximately 6%), Toluen and Methyl Ethly Ketone, wherein those materials and compositions are utilized to produce high water and vapor transmissible characteristic. The solvent-based hydrophilic and vapor-transmissible plastic layer 32 of our invention is specifically designed to have physical state of liquid in room temperature, and has properties of low boiling point that is below 80 degrees Celsius (80° C.). The solvent-based hydrophilic and vapor-transmissible plastic layer 32 also has a high moisture permeability, which is measured approximately 6000 g/m²·24 hr in conditions of a temperature of 23° C. and a relative humidity of 50%. Since the solvent-based hydrophilic and vapor-transmissible plastic layer 32 has very high moisture permeability at room temperature, it can be bonded easily with the inner surface 311 of the fabric body 31. Specific agents and catalysts, such as the ST-55 or ST-32 that have physical state of liquid, are used to mix with the solvent-based hydrophilic and vapor-transmissible plastic layer 32 to strengthen its film properties in such that a thin film of solvent-based hydrophilic and vapor-transmissible plastic layer 32 is formed and bonded to the inner surface 311 of the fabric body 31 firmly.

A low-modulus hydrophilic and vapor-transmissible plastic layer 33 is applied over the solvent-based hydrophilic and vapor-transmissible plastic layer 32. The low modulus and vapor transmissible characteristics of the low-modulus hydrophilic and vapor-transmissible plastic layer 33 provide the fabric body 31 a soft-touch property. The low-modulus hydrophilic and vapor-transmissible plastic layer 33 is elected from a group that comprises Urethane Polymer or a Urethane Polymer composition which comprises Urethane Polymer, Dimethyl formamide (approximately 28%), Toluen and Methyl Ethly Ketone, wherein those compositions are specifically adapted to produce water vapor transmissible and waterproof characteristics. The low-modulus hydrophilic and vapor-transmissible plastic layer 33 of the present invention has properties of low density of 0.89 (water is about 1) and a very low modulus range of 25-30. Due to its low modulus and vapor transmissible characteristics, it can be bonded to the film layer of solvent-based hydrophilic and vapor-transmissible plastic layer 32 easily.

The fabric body 31 further comprises a low-melting-point hydrophilic and vapor-transmissible plastic layer 34 which is provided onto the layer of the low-modulus hydrophilic and vapor-transmissible plastic layer 33. The low-melting-point hydrophilic and vapor-transmissible plastic layer 34 is made from a group comprising polyurethane Resin or a composition comprising Urethane Polymer, Dimethyl formamide (more or less 28%), Toluen and Methyl Ethly Ketone, wherein those materials or compositions are adapted to produce water vapor transmissible and waterproof characteristics. The low-melting-point hydrophilic and vapor-transmissible plastic layer 34 has a very low melting point of −95° C., and its density about 0.86 at 25° C., which is lighter than water (=1).

The materials or compositions of the solvent-based hydrophilic and vapor-transmissible plastic layer 32, the low-modulus hydrophilic and vapor-transmissible plastic layer 33 and the low-melting-point hydrophilic and vapor-transmissible plastic layer 34 are not limited to the above-mentioned chemical groups/materials, other composition and materials that consists of excellent water vapor transmissible and waterproof characteristics can be used in the present invention. Further, the ratio or the percentage of the materials used in the composition is not limited to the above-mentioned figures. The environmental conditions, such as humility or temperature have to be taken in account during the fabrication process in order to provide the best result.

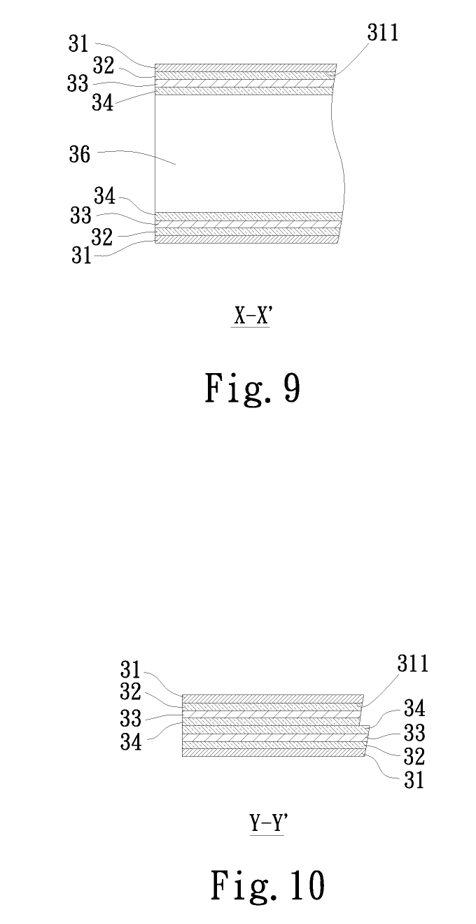

From FIGS. 4 and 9, the fabrication process of the inflatable structure 3 of the present invention is that the solvent-based hydrophilic and vapor-transmissible plastic layer 32 is firstly applied over the inner surface 311 of the fabric body 31. The liquid state of the solvent-based hydrophilic and vapor-transmissible plastic layer 32 is directly applied onto the inner surface 311 of the fabric body 31 via a costing method. Since the properties of the solvent-based hydrophilic and vapor-transmissible plastic layer 32, the layer 32 can be boned onto the inner surface 311 of the fabric body 31 easily and firmly. The liquid state of low-modulus hydrophilic and vapor-transmissible plastic layer 33 is then applied and coated over the layer of the solvent-based hydrophilic and vapor-transmissible plastic layer 32. The liquid state of the low-melting-point hydrophilic and vapor-transmissible plastic layer 34 is sequentially applied and coated onto the layer of the low-modulus hydrophilic and vapor-transmissible plastic layer 33. The liquid states of the solvent-based hydrophilic and vapor-transmissible plastic layer 32, the low-modulus hydrophilic and vapor-transmissible plastic layer 33 and the low-melting-point hydrophilic and vapor-transmissible plastic layer 34 are applied and coated onto an inner surface 311 of another piece of the fabric body 31. The two fabric bodies 31 are sequentially bonded together as shown in FIGS. 4 and 8-10.

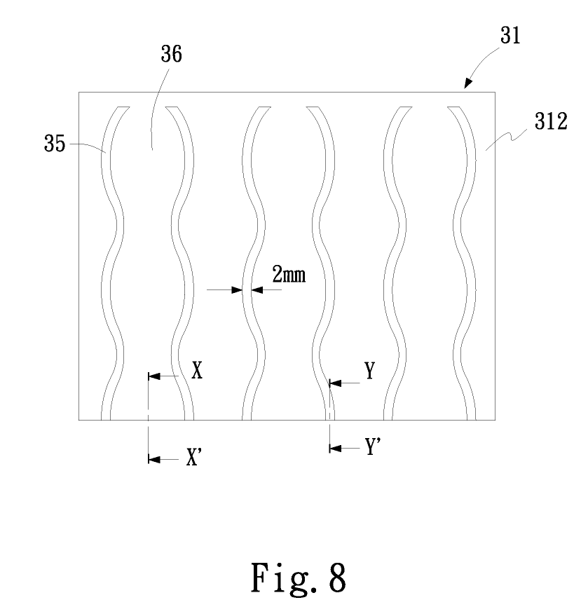

The inner surfaces 311 of the two fabric bodies 31 are sequentially bonded together via a high-frequency lamination method to produce plurality of S-shaped bonding channels 35 shown in FIGS. 4 and 8. From FIGS. 4 and 8-10, the outer surfaces 312 of the two fabric bodies 31 are both exposed externally while the inner surfaces 311 of the two fabric bodies 31 are bonded together via the S-shaped bonding channels 35 by using the high-frequency lamination method in such that spaces 36 are formed in between S-shaped boding channels. Due to the S-shaped bonding design, the inflatable spaces 36 formed in between the channels 35 are enclosed between two s-shaped bonding channels 35 to result a line of loop-shaped space 36 along those s-shaped bonding channels 35 as shown in FIGS. 4 and 8. The S-shaped boding channels are specifically designed to bond the two inner surfaces 311 of the two fabric bodies 31 together so firmly that it can be subjected to high tensile force of over 600 Newton. Refer to FIG. 8, the bonding area (width) of the s-shaped bonding channels 35 is relatively narrowed which is only about 1-2 mm. Although the width of the bonding area is very narrow and small, but the bonding strength of the S-shaped bonding channels 35 is very strong and it can be subjected to high tensile force and high tearing force (approximately above 6.5 Newton) in such that the fabric bodies will have to be completely damaged or torn off in order to separate the fabric bodies.

An inflating valve 37 is provided at the inflatable structure 3 so that the air can be filled into the plurality of inflatable space 36 in order to create the heat insulation as shown in FIG. 3.

The low-melting-point hydrophilic and vapor-transmissible plastic layer 34 has a low melting point and can therefore be easily processed to provide enhanced bonding strength at a bonded area. The three hydrophilic vapor-transmissible plastic layers 32, 33, and 34 have a total thickness ranged from 0.03 mm to 0.05 mm. The preferred example of the present invention is preferably to have total thickness of 0.05 mm of the three hydrophilic vapor-transmissible plastic layers 32, 33, and 34 in order to provide the best result of thermal insulation (heat insulation). Due to the requirement of the small thickness, the three plastic layers 32, 33, 34 together have a relatively low weight of about 60-70 g/m².

The continuous S-shaped bonding channel 35 has two ends formed into a closed circular bonding line 351 each, and this is done by a high-frequency sealing method, supersonic welding, or heat bonding, so that the areas on the outer surface 312 at two opposite sides of the fabric body 31 is bonded along the S-shaped bonding channels 35 to limit an inflated overall thickness of the fabric body 31. The S-shaped bonding channel 35 is preferably formed by high-frequency sealing to achieve a bonding strength up to 150N/5 cm. The closed circular bonding lines 351 formed at two ends of the S-shaped bonding channel 35 facilitate uniform stress distribution. That is, with the two closed circular bonding lines 351, stress would not concentrate at a certain particular position to cause damage of the inflatable structure 3 of the present invention when the same is subjected to a relatively large compression. Moreover, the S-shaped bonding channel 35 has the width which is ranged from 1 to 2 mm, and is preferably 2 mm (shown in FIG. 8). Since the width of the S-shaped bonding line 35 is very small, the overall volume of the inflatable space 36 is advantageously increased to thereby upgrade the warm keeping effect of the inflatable structure 3 (FIGS. 8 and 9).

From FIG. 3, the inflating valve 37 is provided on the fabric body 31 to communicate with the inflatable space 36. An adequate amount of air may be supplied into or released from the inflatable space 36 via the inflating valve 37 according to the user's personal need for keeping warm.

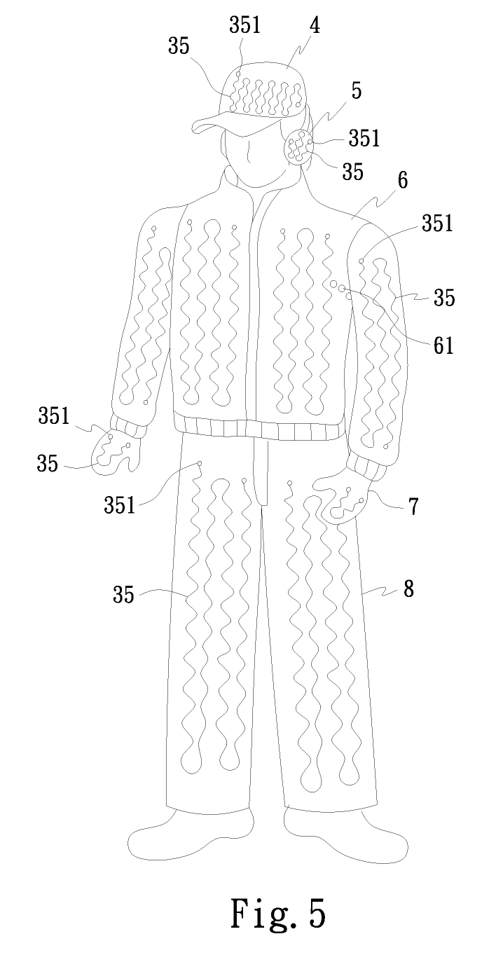

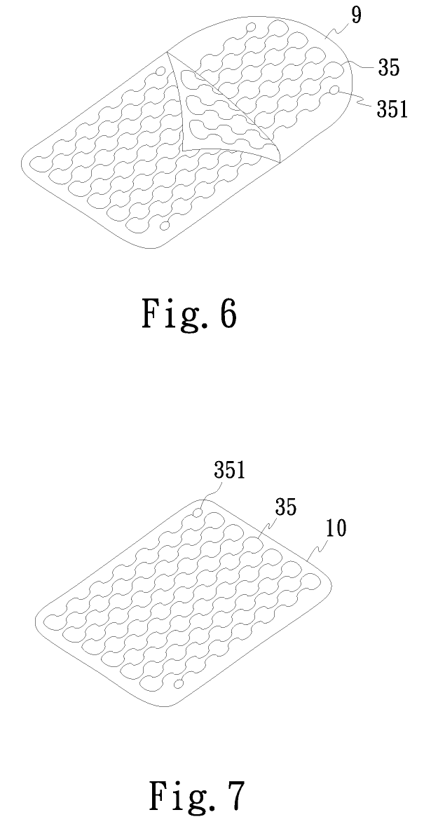

The inflatable structure 3 of the present invention may be used to produce different things, such as, for example, an inflatable hat 4, inflatable earmuffs 5, an inflatable coat 6, inflatable gloves 7, and inflatable trousers 8 as shown in FIG. 5, an inflatable sleeping bag 9 as shown in FIG. 6, and an inflatable quilt 10 as shown in FIG. 7. Taking the inflatable coat 6 made of the inflatable structure 3 of the present invention as an example, since moisture from a wearer's body is allowed to pass through the fabric body 31 and be absorbed by the solvent-based hydrophilic and vapor-transmissible plastic layer 32, and with a water delivery movement existing between the low-modulus hydrophilic and vapor-transmissible plastic layer 33 and the low-melting-point hydrophilic and vapor-transmissible plastic layer 34, moisture absorbed by the solvent-based hydrophilic and vapor-transmissible plastic layer 32 is finally delivered to the external atmosphere. Therefore, the wearer would not feel sweltering while warm air surrounding the wearer's body is kept inside the inflatable coat 6. On the other hand, external cold wind and rainwater are isolated from the wearer's body by the inflatable coat 6 without the risk of penetrating through the three plastic layers 32, 33, and 34. Therefore, the inflatable coat 6 is windproof, waterproof, vapor transmissible, durable, and warm. The inflatable coat 6 may be provided at positions near two armpits with three vents 61 each, so as to facilitate evaporating of sweat at the armpits.

The inflatable structure 3 of the present invention utilizes the solvent-based hydrophilic and vapor-transmissible plastic layer 32, which may be bonded via the high-frequency sealing/high-frequency lamination to provide an increased bonding strength of up to 150N/5 cm, and can therefore extend the usable life of the inflatable structure. Further, the three hydrophilic plastic layers 32, 33, and 34 provide a high vapor transmissibility of more than 5000 g/m² and a high water resistance of more than 10000 M/M, and have an overall thickness less than 0.05 mm and a low weight of 60-70 g/m². The three plastic layers 32, 33, 34 also provide soft touch, making the inflatable structure 3 of the present invention a fabric comfortable for use. The three plastic layers 32, 33, 34 may be applied over the fabric body 31 by any conventionally known way at low processing cost. Moreover, the continuous S-shaped bonding channel 35 with two closed circular bonding lines 351 formed at two ends thereof uniformly distributes any stress thereof without causing concentrated stress at a certain particularly position, and is not easily damaged when the inflatable structure 3 is subjected to a relatively large compression. The small width of less than 2 mm of the S-shaped bonding channel 35 allows an increased inflatable space 36 in the fabric body 31 and accordingly, upgraded warm-keeping effect.

Furthermore, the inflatable structure 3 of the present invention is specifically designed in such that not only its overall weight is lighter than most of conventional inflatable structures and clothes in the market, it also has a very high efficiency of heat retaining/insulating property due to the specific design of 2 mm of S-shaped bonding channels 35.

The temperature test can be used to determine how well the inflatable structure 3 is insulated against temperature changes in order to test the insulating and retaining characteristics of the inflatable structure 3. Since the inflatable structure 3 of the present invention is specifically designed to retain temperature/heat of the user, therefore, when it is subjected to a continuous and standardized radiation/convection exposure, the temperature within the inflatable structure 3 will not change much.

The inflatable structure 3 of the present invention is used to cover a box that is filled with at least ⅓ of it volume of dry ice, and a thermo sensor is located inside the box to detect the changes in temperature every 30 minutes. The test is carried in control conditions to see if the inflatable structure 3 can insulate the box from the changes in temperature inside the inflatable structure 3.

| | Inside | Outside |
|---|---|---|
| | temperature of | temperature of |
| | box (° C.) | box (° C.) |
| Start | −73.4 | 14.1 |
| After 30 min | −73.2 | 10.3 |
| After 60 min | −72.9 | 6.1 |
| After 90 min | −72.8 | 5.8 |
| After 120 min | −72.7 | 6.6 |
| After 150 min | −72.7 | 7.0 |
| After 180 min | −72.4 | 7.3 |

From temperature readings, we can see that the insulating & retaining properties of the inflatable structure 3 are excellent without or barely any lost of temperature. Thus, the inflatable structure 3 of the present invention is successfully retain and insulate the changes of temperature within the structure 3 and can also successfully prevent the heat transferring from the inside of the inflatable structure to the external environment via the convection or/and radiation.

In brief, the inflatable structure 3 of the present invention includes a fabric body 31 that has three hydrophilic and vapor transmissible plastic layers applied thereon, and is bonded together at two opposite sides along at least one narrow but strong continuous S-shaped bonding channel 35 with two closed circular bonding lines 351 formed at two ends thereof, so that the fabric body 31 is light in weight, durable for use, waterproof, and vapor-transmissible, and provides the largest possible inflatable space to enable good warm keeping effect, making the inflatable structure 3 of the present invention industrial valuable and practical for use to meet the market demands.

What is claimed is:

1. An inflatable structure, comprising:
two fabric bodies, wherein each fabric body has an inner surface and an outer surface;
a solvent-based hydrophilic and vapor-transmissible plastic layer applied over the inner surfaces of the fabric body;
a low-modulus hydrophilic and vapor-transmissible plastic layer provided over the solvent-based hydrophilic and vapor-transmissible plastic layer;
a low-melting-point hydrophilic and vapor-transmissible plastic layer provided over the low-modulus hydrophilic and vapor-transmissible plastic layer;
wherein once all the layers are applied onto the inner surfaces of the fabric bodies, the inner surfaces of the fabric bodies are bonded together to form at least one continuous S-shaped bonding channel and an inflatable space is formed and enclosed by the S-shaped bonding channels, and areas on the outer surface at two opposite sides of the fabric bodies are bonded together to limit an inflated overall thickness of the fabric body, and the S-shaped bonding channel is formed at two ends with a closed circular bonding line each; and
an inflating valve provided on the fabric body to communicate with the inflatable space, so that air is supplied into or released from the inflatable space via the inflating valve;

2. The inflatable structure as claimed in claim 1, wherein the fabric body is made of a material selected from the group consisting of Nylon 66.

3. The inflatable structure as claimed in claim 1, wherein the solvent-based, the low-modulus, and the low-melting-point hydrophilic and vapor-transmissible plastic layer have a total thickness ranged from 0.03 mm to 0.05 mm.

4. The inflatable structure as claimed in claim 3, wherein the solvent-based, the low-modulus, and the low-melting-point hydrophilic and vapor-transmissible plastic layer have a total thickness of 0.05 mm.

5. The inflatable structure as claimed in claim 1, wherein the continuous S-shaped bonding channel is formed in a manner selected from the group consisting of high-frequency lamination, supersonic welding, and heat bonding methods.

6. The inflatable structure as claimed in claim 5, wherein the continuous S-shaped bonding channel is formed by high-frequency lamination method.

7. The inflatable structure as claimed in claim 1, wherein the continuous S-shaped bonding channel has a width ranged from 1 mm to 2 mm.

8. The inflatable structure as claimed in claim 7, wherein the continuous S-shaped bonding channel has a width of 2 mm.

9. The inflatable structure as claimed in claim 1, wherein the warm-keeping articles are selected from the group consisting of inflatable hats, inflatable earmuffs, inflatable coats, inflatable gloves, inflatable trousers, inflatable sleeping bags, and inflatable quilts.

10. The inflatable structure as claimed in claim 9, wherein the inflatable coats are provided at a position near each armpit with at least one vent.

11. The inflatable structure as claimed in claim 1, wherein the solvent-based hydrophilic and vapor-transmissible plastic layer is selected from a group that comprises Urethane Polymer or a composition comprising Urethane Polymer, Dimethyl formamide, Toluen and Methyl Ethly Ketone.

12. The inflatable structure as claimed in claim 1, wherein the low-modulus hydrophilic and vapor-transmissible plastic layer is selected from a group comprising Urethane Polymer or a Polymer composition which comprises Urethane Polymer, Dimethyl formamide, Toluen and Methyl Ethly Ketone.

13. The inflatable structure as claimed in claim 1, wherein the low-melting-point hydrophilic and vapor-transmissible plastic layer is made from a group comprising polyurethane Resin or a composition comprising Urethane Polymer, Dimethyl formamide, Toluen and Methyl Ethly Ketone.
